(19) United States
(12) Patent Application Publication
(10) Pub. No.: US 2002/0085556 A1
(43) Pub. Date: Jul. 4, 2002

(54) Channel and method for forward transmission of data

(75) Inventor: Sung Hyuk Hong, Suwon-shi (KR)

Correspondence Address: FLESHNER & KIM, LLP, P.O. Box 221200, Chantilly, VA, 20153-1200, US

(73) Assignee: LG Electronics Inc.

(21) Appl. No.: 10/029,252

(22) Filed: Dec. 28, 2001

(30) Foreign Application Priority Data
Dec. 29, 2000 (KR) 2000-85328

(51) Int. Cl. H04L 12/28

(52) U.S. Cl. 370/389; 370/470

(57) ABSTRACT

The present invention relates to a mobile communication system, and more particularly, to channel and method for forward transmission of a data employed for high speed data service. The forward data transmission channel permits a number of subscribers to share a channel in a time sharing method, thereby accommodating high speed data service subscribers at a time, and reducing signaling overhead occurred for adjusting the data transmission rate.

This application claims the benefit of the Korean Application No. P2000-85328 filed on Dec. 29, 2000, which is hereby incorporated by reference.

### BACKGROUND OF THE INVENTION

1. Field of the Invention

The present invention relates to a mobile communication system, and more particularly, to channel and method for forward transmission of a data employed for high speed data service.

2. Background of the Related Art

In general, a mobile station in a CDMA third generation mobile communication system has, not one traffic channel structure for transmission of only one traffic channel the same as IS-95A, but a multi-channel structure which transmits a plurality of traffic channels at a time for providing a variety of multimedia services, such as audio, video, and data.

The multi-channel has a fundamental channel for transmission of information, such as voice, and the like, a dedicated control channel for transmission of dedicated control information, and additional supplemental channels (SCH) for data transmission.

FIG. 1 illustrates a related art frame of a forward supplemental channel.

Referring to FIG. 1, fields in the forward supplemental channel frame have different number of bits depending on data transmission rates ofthe forward supplementalchannels The forward supplemental channel has a reserved field, an information bit field, and a frame quality indicator ‘F’ field, a reserved/encoder tail bit R/T field.

The information bit field is provided with multiplexed protocol data units (MuxPDUs), and error detection codes (for an example, Cyclic Redundancy Check; CRC), arranged alternately.

The SCH, having a frame structure as shown in FIG. 1, is allocated to each user call by call. The information bits in the frame are dedicated to the specific call. A data transmission rate of the forward supplemental channel varies with an amount of data transmitted to a mobile station connected with a particular call as far as the call is setup.

All the forward channels in the CDMA mobile communication system are identified by orthogonal codes, for an example, Walsh codes. A length of the orthogonal codes is reduced inversely proportional to a channel rate. The reduction of the length of the orthogonal codes implies that resources of the orthogonal codes are used as the much. Owing to above reason, only extremely few number of the SCHs at high data transmission rates can be allocated to relevant mobile stations.

In the meantime, in order to increase available orthogonal code resources, a quasi orthogonal function (QOF) may be used, when it is required to accept a certain extent of performance deterioration because the orthogonal codes derived from the QOF are not perfect orthogonal.

Due to above reasons, some of the high speed data services dynamically change rates of the SCHs as much as required, for meeting individual service quality requirements, and increasing a total service capacity.

However, since the SCHs are allocated call by call in the high speed data service, a number of admissible subscribers for the high speed data service at a time is limited to an extremely small number because the faster the data transmission rate of the allocated SCH, the more the consumption of the orthogonal code resources.

Moreover, the necessity to vary the SCH dynamically with the data rate causes frequent signaling, that causes overhead on the whole system.

Furthermore, if the data transmission rate control of the SCH is made independently for each channel, impartial, appropriate level of services may not be provided to all subscribers.

### SUMMARY OF THE INVENTION

Accordingly, the present invention is directed to a channel and method for forward transmission of a data that substantially obviates one or more of the problems due to limitations and disadvantages of the related art.

An object of the present invention is to provide a channel arid method for forward transmission of a data, in which a forward supplemental channel is allocated to many calls in common.

Another object of the present invention is to provide a channel and method for forward transmission of a data, in which a forward supplemental channel is shared by many subscribers in a time sharing method.

Further object of the present invention is to provide a channel and method for forward transmission of a data, in which an overhead is reduced.

Additional features and advantages of the invention will be set forth in the description which follows, and in part will be apparent from the description, or may be learned by practice of the invention. The objectives and other advantages of the invention will be realized and attained by the structure particularly pointed out in the written description and claims hereof as well as the appended drawings.

To achieve these and other advantages and in accordance with the purpose of the present invention, as embodied and broadly described, the channel frame for forward transmission of data includes a header subframe containing frame mapping information of data to be transmitted to a plurality of terminals, and data subframes containing data multiplexed therein, and to be transmitted to a plurality of terminals at the present time in correspondence to frame mapping information transmitted in advance.

In another aspect of the present invention, there is provided a method for forward transmission of a data, including the steps of (a) processing data to be transmitted at the present time to form subframes, (b) multiplexing the formed subframes according to subframe mapping information transmitted in advance, and (c) transmitting the multiplexed subframes, together with subframe mapping information of the subframes to be transmitted thereafter.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention:

In the drawings:

FIG. 1 illustrates a related art frame of a forward supplemental channel;

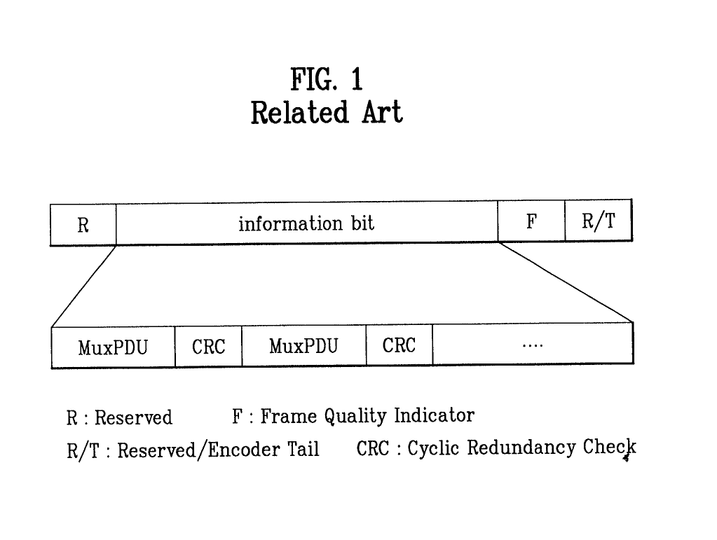

FIG. 2 illustrates a frame of a common forward supplemental channel in accordance with a preferred embodiment of the present invention; and,

FIG. 3 illustrates a mapping relation between SFN and a data subframe in a forward supplemental channel of the present invention.

### DETAILED DESCRIPTION OF THE PREFERRED EMBODIMENT

Reference will now be made in detail to the preferred embodiments of the present invention, examples of which are illustrated in the accompanying drawings.

A general type of use of a packet data service subscriber is downloading of information from a server. That is, major data flows are in forward directions, and, that is, in burst in which the data flow is made at a short time period in comparison to a total connection time period.

Therefore, when many packet data service subscribers use the service at a time, a momentary sum of the data flow of the subscribers will be constant with respect to time. In this point of view, there will be many advantages if an SCH at a high speed data transmission rate is shared by many service subscribers in a time sharing method.

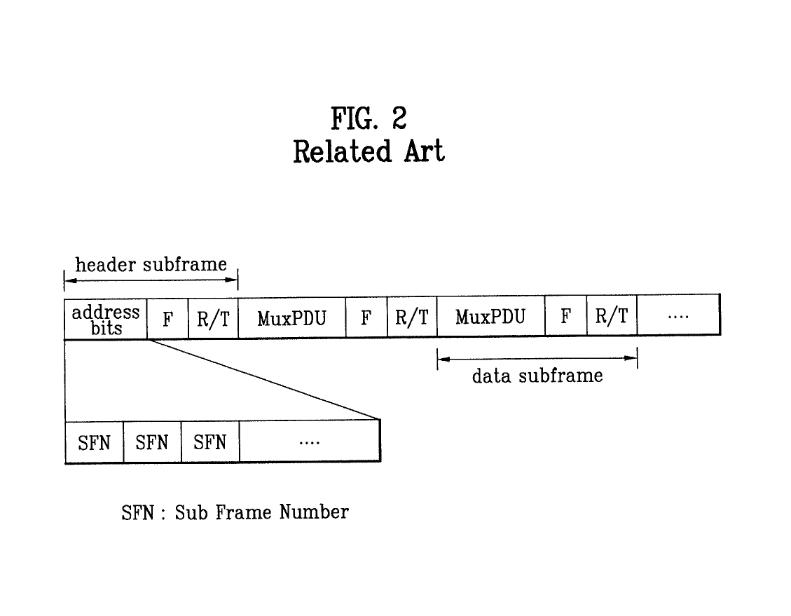

Accordingly, the present invention suggests system and transmission method of a common forward supplemental channel (CFSCH), which will be explained with reference to FIG. 2. The common forward supplemental channel is a general name of a channel for data transmission. Call setup for using the common forward supplemental channel is made together with other terminals in common.

FIG. 2 illustrates a frame of a common forward supplemental channel in accordance with a preferred embodiment of the present invention.

Referring to FIG. 2, the frame of a common forward supplemental channel in accordance with a preferred embodiment of the present invention includes a plurality of data subframes containing subscriber data, and a header subframe having information which of the plurality of data subframes contains information on which subscriber.

The data subframe includes a MuxPUD containing a subscriber data, a frame quality indicator ‘F’, and a reserved/encoder tail bit ‘R/T’. The header subframe has address bits including a plurality of sub frame number (SFN), a frame quality indicator ‘F’, and reserved/encoder tail bits R/T.

The data subframe is multiplexed in the frame after the data subframe is subjected to channel coding steps, such as convolutional/turbo encoding, symbol repetition, block interleaving, long code scrambling, and the like, which are carried out in frame units in a general CDMA (Code Division Multiple Access) system.

In this instance, for permitting decoding of the frame contents by all terminals related to the CFSCH, one common long code is used in the header subframe, while the data subframe uses a long code allocated to the subscriber for permitting decoding by the subscriber. A number of the data subframes included in one frame of the CFSCH is proportional to a data transmission rate of the CFSCH.

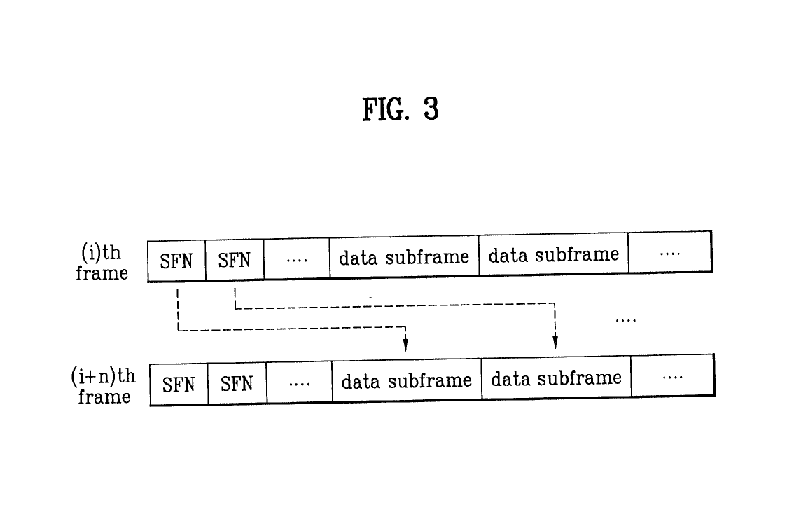

FIG. 3 illustrates a mapping relation between SFN and a data subframe in a forward supplemental channel of the present invention.

Referring to FIG. 3, the SFN in the header subframe in the CFSCH of the present invention represents information that the data subframe included in an (n)th frame from the present frame is to be provided to which subscriber. The ‘n’ is an integer inclusive of ‘0’ dependent on a receiver performance. For an example, if one subscriber uses CFSCH, an arbitrary SFN is allocated to the subscriber. The allocated SFN serves as an address of the data subframe during the subscriber uses the CFSCH.

A number of SFNs in the address bits of the header subframe is as many as a number of data subframes included in the CFSCH, and, as shown in FIG. 3, each of the SFNs has respective data subframes mapped thereto in succession in one to one fashion. In other words, according to an order of transmission of the SFNs transmitted ‘n’ frames before, the data subframes transmitted thereafter are multiplexed positioned in a frame.

That is, each of the subscribers who uses service through CFSCH receives a header subframe for each of the frames, and identifies the SFN value. After identifying a SFN the same with a SFN allocated to the subscriber himself, the subscriber receives the data subframe mapped with the SFN at the next (n)th frame.

A subscriber's data arrived (or produced) at the CFSCH frame multiplexer at first is contained in the frame at first in view of competition principle. If necessary, a scheduling type may be applied to the CFSCH frame multiplexer, in which, for an example, soft handoff, or subscriber classes may be applied.

However, if the number of data subframe lacks to fill the frame fully, a section of the frame no data subframe is provided thereto has power supply thereto turned off.

A system manager may fix the data transmission rate of the CFSCH according to service area characteristics, or automatically vary every moment depending on a number of high speed data service requesting subscribers.

Other than general services, the CFSCH may be utilized as a broadcasting channel, which is made possible by allocating at least one particular data subframe to the broadcasting. That is, a broadcasting data is included in one of data subframes, and an information value representing broadcasting is setup at a relevant SFN field of a header subframe. In this instance, the broadcasting data subframe is formed as relevant subscriber data is scrambled with a long code known to the subscribers in its service area.

As has been explained, the common forward supplemental channel in the mobile communication system of the present invention can accommodate many high speed data service subscribers at a time, can reduce signaling overhead frequently occurred in the related art for adjustment of data transmission rate, can easily make service levels to all subscribers uniform by making a plurality of subscribers share the channel in competition basis, and can easily secure required service levels for service classification of subscribers through one multiplxer control.

It will be apparent to those skilled in the art that various modifications and variations can be made in the channel and method for forward transmission of a data of the present invention without departing from the spirit or scope of the invention. Thus, it is intended that the present invention cover the modifications and variations of this invention provided they come within the scope of the appended claims and their equivalents.

What is claimed is:

1. A channel for forward transmission of a data comprising:
a header subframe containing frame mapping information of data to be transmitted to a plurality of terminals; and,
data subframes containing data multiplexed therein, and to be transmitted to a plurality of terminals at the present time in correspondence to frame mapping information transmitted in advance.

2. A channel as claimed in claim 1, wherein the frame mapping information transmitted in advance is transmitted ‘n’ frames before contained in other frame.

3. A channel as claimed in claim 2, wherein the frame mapping information transmitted in advance is transmitted ‘n’ frames before contained in other frame, and contains information on positions of the multiplexed data subframes in the frame.

4. A channel as claimed in claim 3, wherein the frame mapping information transmitted in advance is subframe numbers transmitted ‘n’ frames before to other frame in succession, and the multiplexed data subframes are positioned in the frame according to an order of transmission of the subframe numbers.

5. A channel as claimed in claim 1, wherein the header subframe contains data subframe numbers, frame quality indicator, and reserved/encoder tail information.

6. A channel as claimed in claim 1, wherein the data subframe contains data to be transmitted to a relevant terminal, frame quality indicators, and reserved/encoder tail information.

7. A channel as claimed in claim 1, wherein the header subframe is scrambled in a code all the terminals know.

8. A channel as claimed in claim 1, wherein the data subframes are encoded in codes only relevant terminals know.

9. A channel as claimed in claim 1, wherein the data subframes are multiplexed according to an order of generation.

10. A channel as claimed in claim 1, wherein the data subframes are multiplexed according to priorities of the terminals.

11. A channel as claimed in claim 1, wherein the data subframes are encoded, symbol repeated, interleaved, and scrambled.

12. A channel as claimed in claim 1, wherein, in case the data subframe can not complete one frame fully, a power supply for a section of the frame without data transmission is turned off.

13. A channel as claimed in claim 1, wherein at least one of the data subframes contains a broadcasting data to be transmitted to all terminals.

14. A channel as claimed in claim 13, wherein the frame mapping information of the data subframe that transmits the broadcasting data is transmitted ‘n’ frames before to a header subframe of other frame.

15. A channel as claimed in claim 13, wherein the data subframe that transmits the broadcasting data is scrambled with codes known to all terminals that use the broadcasting service.

16. A method for forward transmission of a data, comprising the steps of:
(a) processing data to be transmitted at the present time to form subframes;
(b) multiplexing the formed subframes according to subframe mapping information transmitted in advance; and,
(c) transmitting the multiplexed subframes, together with subframe mapping information of the subframes to be transmitted thereafter.

17. A method as claimed in claim 16, wherein the step (a) includes the steps of; encoding, symbol repetition, interleaving, and scrambling for forming subframes.

18. A method as claimed in claim 16, further comprising the steps of:
a terminal being allocated with a subframe number of the terminal;
the terminal receiving subframe mapping information, and determining containment of the subframe number of the terminal; and,
the terminal receiving a data for the terminal after ‘n’ frames at a position the subframe number indicates, if the subframe number of the terminal is contained as a result of the determination.

19. A method as claimed in claim 16, wherein the formed subframes are multiplexed according to an order of formation.

20. A method as claimed in claim 16, wherein the formed subframes are multiplexed according to priorities of the terminals.

21. A method as claimed in claim 16, wherein the frame mapping information is scrambled with codes all the terminals know.

22. A method as claimed in claim 16, wherein the subframes are scrambled with codes only a relevant terminal knows.

23. A method as claimed in claim 16, wherein the number of formed subframes is increased/decreased in proportion to a transmission rate of a data transmission channel.
